(19) United States
(12) Patent Application Publication
(10) Pub. No.: US 2026/0197042 A1
(43) Pub. Date: Jul. 9, 2026

(54) BASE STATIONS INCLUDING BASE STATION ANTENNAS HAVING MULTI-BEAM ANTENNA ARRAYS THAT ARE CONFIGURED TO OPERATE WITH RADIOS HAVING DIFFERENT MAXIMUM OUTPUT POWER LEVELS

(71) Applicant: Outdoor Wireless Networks LLC, Richardson, TX (US)

(72) Inventors: Mikko Junttila, Oulu (FI); Azzeddin Naghar, Mordelles (FR)

(21) Appl. No.: 19/441,309

(22) Filed: Jan. 6, 2026

Related U.S. Application Data
(60) Provisional application No. 63/743,336, filed on Jan. 9, 2025.

(51) Int. Cl. H04B 7/0426; H01Q 5/20; H04B 7/0408; H04B 7/0452; H01Q 1/24

(52) U.S. Cl. CPC H04B 7/0434; H01Q 5/20; H04B 7/0408; H04B 7/0452; H01Q 1/246

(57) ABSTRACT

A cellular base station comprises a base station antenna that includes a first set of RF ports that has a total of N first polarization RF ports, where N is an integer that is greater than 2, a first multi-column array of radiating elements that is configured to generate N first polarization antenna beams that include a first pair of outer antenna beams and a first inner antenna beam, and a first beamforming network that electrically connects the first set of RF ports to the first multi-column array of radiating elements. The base station further includes first and second radios that have respective ports that are coupled to first and second of the N first polarization RF ports, where the first radio has a first maximum output power level and the second radio has a higher second maximum output power level.

### CROSS REFERENCE TO RELATED APPLICATION

The present application claims priority under 35 U.S.C. § 119 to U.S. provisional patent application Serial No. 63/743,336, filed January 9, 2025, the entire content of which is incorporated herein by reference.

### FIELD OF THE INVENTION

The present invention generally relates to cellular communications systems and, more particularly, to cellular base stations having base station antennas with multi-beam antenna arrays.

### BACKGROUND

Cellular communications systems are well known in the art. In a typical cellular communications system, a geographic area is divided into a series of regions that are referred to as "cells," and each cell is served by a base station. The base station may include baseband equipment, radios and base station antennas that are configured to provide two-way radio frequency ("RF") communications with subscribers that are positioned throughout the cell. In many cases, the cell may be divided into a plurality of "sectors," and separate base station antennas, radios and baseband equipment provide service to each of the sectors. The base station antennas are often mounted on a tower or other raised structure, with the radiation beams ("antenna beams") that are generated by each antenna directed outwardly to serve a respective sector.

A common base station configuration in a cellular communications network is a "three sector" configuration in which each cell is divided into three 120º sectors in the azimuth plane. The azimuth plane refers to a horizontal plane that bisects the base station antenna and that is parallel to the plane defined by the horizon. In a three-sector configuration, the base station may include three "sector" base station antennas that provide coverage to three respective hexagonally-shaped sectors. Typically, each sector base station antenna will include one or more phase-controlled arrays of dual-polarized radiating elements, with the radiating elements in each array arranged in a vertically-extending column (i.e., a column that is perpendicular relative to the plane defined by the horizon) when the antenna is mounted for use. Such single column arrays are commonly referred to as "linear arrays", and are configured to generate a pair of antenna beams in response to a pair of RF signals that are passed to the respective first polarization and second polarization radiators of the dual-polarized radiating elements. Most modern base station antennas are multi-band base station antennas that include linear arrays that operate in two or more different frequency bands, and often includes multiple linear arrays in each frequency band. The antenna beams generated by each linear array in a sector base station antenna typically have a Half Power Beam Width ("HPBW") in the azimuth plane of about 65º so that the antenna beams provide good coverage throughout a 120º sector.

Most base station antennas also include remotely controlled phase shifter circuits along the RF transmission paths through the antenna that allow a phase taper to be applied to the sub-components of an RF signal that are supplied to the radiating elements in an array. By adjusting the amount of phase taper applied, the resulting antenna beams may be electrically downtilted to a desired degree in the vertical or "elevation" plane. This technique may be used to adjust how far an antenna beam extends outwardly from an antenna, and hence can be used to adjust the coverage area of the base station antenna.

Sector-splitting refers to a technique where the coverage area for a base station antenna is sub-divided into two or more sub-sectors in the azimuth plane. Sector-splitting can be performed at all three sectors of a three-sector base station, or at less than all three sectors. Moreover, sector splitting is often only done in a single one of multiple frequency bands supported by a base station antenna. For example, a base station antenna may support service in both the "low-band" frequency band (the 616-960 MHz frequency range of a portion thereof) and in the "mid-band" frequency band (the 1427-2690 MHz frequency range or a portion thereof), but may only sector-split in the mid-band frequency band. Sector-splitting is typically implemented by deploying base station antennas that have multi-column antenna arrays that, in conjunction with associated beamforming networks, can simultaneously generate two or more narrower beamwidth antenna beams that provide coverage to the respective sub-sectors.

A twin-beam base station antenna is a base station antenna includes at least one twin-beam antenna array that splits a 120⁰ sector in the azimuth plane into two 60⁰ sub-sectors.

Splitting each 120º sector into two 60⁰ sub-sectors increases system capacity because each antenna beam provides coverage to a smaller area, and therefore provides higher antenna gain. The twin-beam antenna array generates two separate antenna beams that each have a reduced size in the azimuth plane and that each point in different directions in the azimuth plane, thereby splitting the sector into two smaller sub-sectors. A tri-beam base station antenna is a base station antenna that includes at least one antenna array that splits a 120⁰ sector in the azimuth plane into three 40⁰ sub-sectors, which further increases the capacity of the base station.

A twin-beam array will typically have 3-4 columns of radiating elements, while a tri-beam array will typically have 4-6 columns of radiating elements. In each case, the multi-column array is mounted in front of a flat reflector so that each column of radiating elements points toward the boresight pointing direction of the antenna. The boresight pointing direction of a base station antenna refers to a direction perpendicular to the front surface of the antenna, and typically is the direction that points toward the center of the sector served by the base station antenna. RF ports of the base station antenna are coupled to the multi-column array through a beamforming network (or through a pair of beamforming networks if the array includes dual-polarized radiating elements). For a twin-beam antenna, two RF ports (per polarization) are coupled to the multi-column array through the beamforming network(s), while for a tri-beam antenna, three RF ports (per polarization) are coupled to the multi-column array through the beamforming network(s).

Most cellular communications employ multi-input-multi-output ("MIMO") communications techniques. MIMO refers to a technique where a baseband data stream is sub-divided into multiple sub-streams that are appropriately coded and the coded sub-streams are used to generate multiple RF signals that are transmitted via respective antenna beams. The antenna beams are sufficiently decorrelated with each other so that when the multiple RF signals are recovered at the receiver and demodulated and decoded, the original data sub-streams may be recovered and recombined. The decorrelated antenna beams may be generated by transmitting the RF signals corresponding to different sub-streams using different (orthogonal) polarizations and/or by transmitting the sub-streams through different antenna arrays that are spaced far enough apart (e.g., spaced apart by a wavelength corresponding to the center frequency of the RF signal) to be decorrelated with respect to negative effects of the wireless channel. The use of MIMO communications techniques may help overcome multipath fading effects, and may be particularly effective in urban environments where reflections may increase the level of decorrelation between the RF signals. The "degree" of a MIMO communications technique refers to the number of different sub-streams used, which may be the same or different for the transmit and receive paths. A MIMO communications technique that has four sub-streams for signals transmitted (T) by a base station antenna and that has two sub-streams for signals received (R) at the base station antenna is referred to as a 4T/2R MIMO scheme. If instead there are four sub-streams for received signals, the MIMO scheme is referred to as a 4T/4R MIMO scheme (or a 4xMIMO scheme). A four port cellular radio is used to transmit and receive signals using 4T/4R MIMO techniques, with each port of the radio transmitting and receiving one of the four sub-streams.

### SUMMARY

Pursuant to embodiments of the present invention, cellular base stations are provided that comprise a base station antenna, a first radio and a second radio. The base station antenna comprises a first set of RF ports that has N first polarization RF ports, where N is an integer that is greater than 2, a first multi-column array of radiating elements that is configured to generate N first polarization antenna beams, the N first polarization antenna beams including a first pair of outer first polarization antenna beams and a first inner first polarization antenna beam, and a first beamforming network that electrically connects the first set of RF ports to the first multi-column array of radiating elements. The first radio has a first radio port that is coupled to a first of the N first polarization RF ports in the first set of RF ports, the first radio having a first maximum output power level. The second radio has a first radio port that is coupled to a second of the N first polarization RF ports in the first set of RF ports, the second radio having a second maximum output power level that is greater than the first maximum output power level.

In some embodiments, a first RF signal that is output through the first radio port of the first radio may be configured to generate one of the outer first polarization antenna beams. A second RF signal that is output through the first radio port of the second radio may be configured to generate the first inner first polarization antenna beam.

In some embodiments, the second maximum output power level is at least 30% larger or at least 50% larger than the first maximum output power level.

In some embodiments, the multi-column array of radiating elements may comprise a tri-beam array such that N is equal to 3.

In some embodiments, the base station antenna may further comprise a second set of RF ports that has a total of N second polarization RF ports and a second beamforming network that electrically connects the second set of RF ports to the first multi-column array of radiating elements. In such embodiments, the first radio may have a second radio port that is coupled to a first of the N second polarization RF ports in the second set of RF ports and the second radio may have a second radio port that is coupled to a second of the N second polarization RF ports in the second set of RF ports.

In some embodiments, the base station antenna may also comprise a third set of RF ports that has a total of N first polarization RF ports, a second multi-column array of radiating elements that is configured to generate a second set of N first polarization antenna beams, the second set of N first polarization antenna beams including a second pair of outer first polarization antenna beams and a second inner first polarization antenna beam, and a third beamforming network that electrically connects the third set of RF ports to the second multi-column array of radiating elements. In such embodiments, the first radio may have a third radio port that is coupled to a first of the N first polarization RF ports in the third set of RF ports and the second radio may have a third radio port that is coupled to a second of the N first polarization RF ports in the third set of RF ports.

In some embodiments, the first multi-column array of radiating elements may comprise radiating elements that are configured to operate in at least a portion of a 1427-2690 MHz frequency band. In some embodiments, the base station antenna may further comprise a first array of radiating elements that are configured to operate in at least a portion of a 616-960 MHz frequency band and a second array of radiating elements that are configured to operate in at least a portion of the 616-960 MHz frequency band.

In some embodiments, the first radio and the second radio may each be 4-transmit/4-receive ("4T/4R") MIMO radios.

Pursuant to further embodiments of the present invention, cellular base stations are provided that comprise a base station antenna that includes a first beamforming network that is coupled to a sector-splitting antenna array, the first beamforming network and the sector-splitting antenna array configured to generate at least three first polarization antenna beams in response to respective first, second and third RF signals. The cellular base station further includes a first radio, a second radio and a third radio that are coupled to the first beamforming network and a power distribution system that is configured to supply up to a first maximum amount of power to the first radio and to supply up to a second maximum amount of power to the second radio that is greater than the first maximum amount of power.

In some embodiments, the power distribution system may further be configured to supply up to a third maximum amount of power to the third radio, where the third maximum amount of power is less than the second maximum amount of power.

In some embodiments, the base station antenna further comprises a second beamforming network that is also coupled to the sector-splitting antenna array, the second beamforming network and the sector-splitting antenna array configured to generate at least three second polarization antenna beams. In some embodiments, the first polarization antenna beams have a -45 degree slant polarization and the second polarization antenna beams have a +45 degree slant polarization.

In some embodiments, the first polarization antenna beams comprise a first pair of outer first polarization antenna beams and a first inner antenna beam that is positioned in between the antenna beams of the first pair of antenna beams. In some embodiments, the second radio is coupled to an input of the first beamforming network that corresponds to the first inner antenna beam. In some embodiments, a high seating capacity venue is within a sector served by the base station antenna and the high-capacity venue is within a main lobe of the first inner antenna beam.

In some embodiments, the second maximum amount of power is at least 30% larger than the first maximum amount of power.

In some embodiments, the first radio is coupled to a first output of the power distribution system and the second radio is coupled to a second output of the power distribution system, and the power distribution system is configured to supply up to a first maximum amount of direct current (“DC”) power to the first output of the power distribution system and up to a second maximum amount of DC power to the second output of the power distribution system, where the second maximum amount of DC power is at least 30% greater than the first maximum amount of DC power.

### BRIEF DESCRIPTION OF THE DRAWINGS

FIG. 1 is a schematic plan view of a cellular network illustrating how each base station may provide service to three hexagonally-shaped sectors.

FIG. 2A is an enlarged view of a small portion of FIG. 1 that schematically illustrates an antenna beam generated by a linear array of a conventional sector base station antenna.

FIG. 2B is an enlarged view of a small portion of FIG. 1 that schematically illustrates the antenna beams generated by a twin-beam array of a conventional twin-beam base station antenna.

FIG. 2C is an enlarged view of a small portion of FIG. 1 that schematically illustrates the antenna beams generated by a tri-beam array of a conventional tri-beam base station antenna.

FIG. 3A is a schematic block diagram of some of the equipment for one sector of a conventional three-sector base station that includes a base station antenna that has two low-band linear arrays and two twin-beam mid-band arrays.

FIGS. 3B and 3C are polar graphs of the radiation patterns as a function of azimuth pointing angle for the twin-beam mid-band arrays of the base station antenna of FIG. 3A.

FIG. 4A is a schematic block diagram of some of the equipment for one sector of a three-sector base station that includes a base station antenna that has two low-band linear arrays and two tri-beam mid-band arrays.

FIGS. 4B and 4C are polar graphs of the radiation patterns as a function of azimuth pointing angle for the tri-beam mid-band arrays of the base station antenna of FIG. 4A.

FIG. 5 is a schematic block diagram of some of the equipment for one sector of a base station according to embodiments of the present invention that includes a base station antenna having two low-band linear arrays and two tri-beam mid-band arrays.

FIG. 6 is a graph showing the effective isotropic radiated power ("EIRP") as a function of azimuth pointing angle for the twin-beam mid-band antenna beams generated by the conventional base station of FIG. 3 and for the tri-beam mid-band antenna beams generated by the base station of FIG. 5.

FIG. 7 is a schematic block diagram of some of the equipment for one sector of a three-sector base station according to further embodiments of the present invention.

Herein, when multiple of the same elements are included in a base station or base station antenna, the elements may be identified using reference numbers that have two numbers that are separated by a hyphen. Such elements may be referred to individually herein by their full reference numeral and collectively by the first (left) part of their reference numerals.

### DETAILED DESCRIPTION

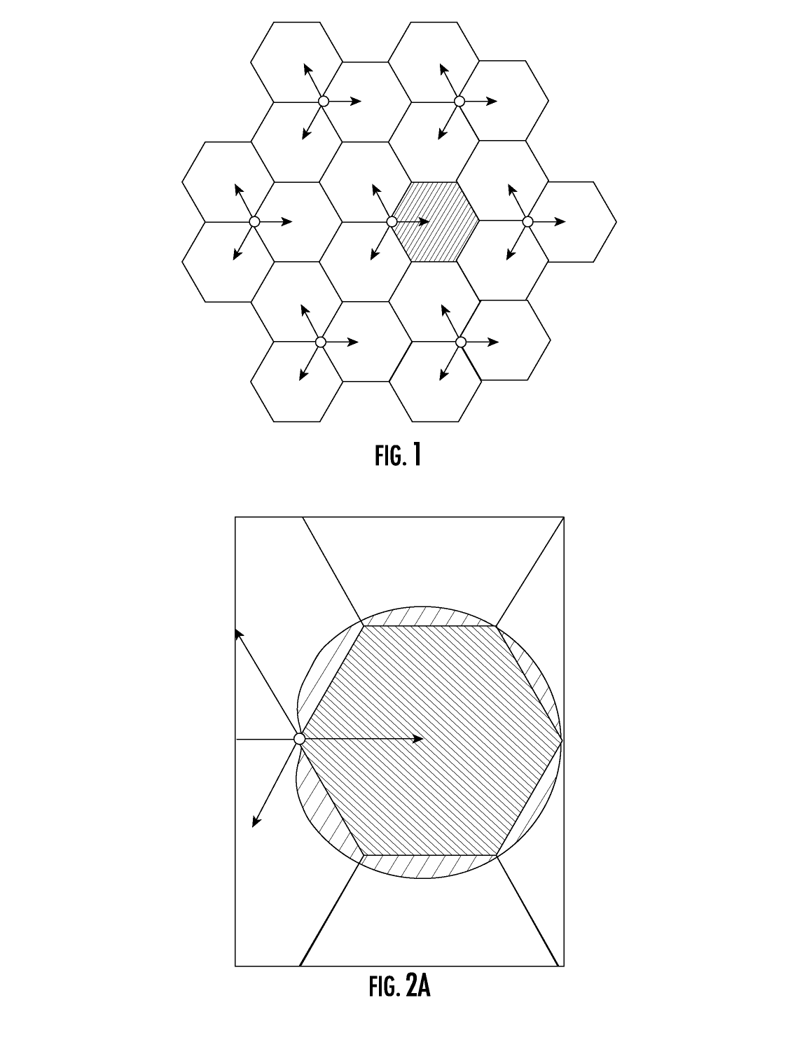

FIG. 1 is a schematic plan view of the macro cells of a typical cellular network. As shown in FIG. 1, a geographic region is divided into a plurality of hexagonally-shaped regions, where each hexagonally-shaped region comprises a "sector." A base station is located at the points where three of the hexagonally-shaped sectors meet (shown by small circles in FIG. 1). The three hexagonally-shaped sectors form a "cell" of the network. The base station may include three base station antennas that point outwardly to provide service to the three respective sectors. The arrows extending outwardly from the small circles show the boresight pointing directions of the respective base station antennas. Ideally, each base station antenna would generate an antenna pattern that only provided RF power within its assigned sector without spilling any RF energy over into the other sectors of the base station or into the sectors of neighboring base stations. Unfortunately, conventional antenna beams do not match the shape of the sectors, and hence conventional base station antennas generate antenna beams that can spill significant amounts of RF energy into neighboring sectors

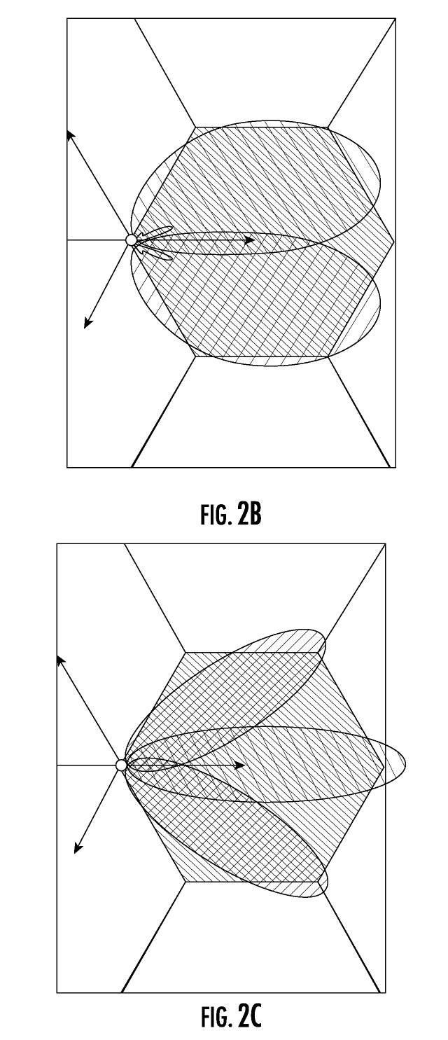

FIGS. 2A-2C are several enlarged views of a small portion of FIG. 1 that schematically illustrate the antenna beams generated by a conventional linear array, a conventional twin-beam antenna array, and a conventional tri-beam antenna array, respectively.

As shown in FIG. 2A, a conventional linear array generates a single antenna beam (per polarization) that provides coverage to the entire 120⁰ sector. The sector antenna beam may provide good coverage throughout the center of each sector, and has some amount of spillover of RF energy into neighboring sectors. As shown in FIG. 2B, a conventional twin-beam antenna array generates a pair of narrower antenna beams (per polarization), with the best coverage (i.e., highest gain) provided at about -/+30⁰ off the boresight pointing direction of the antenna. The coverage at the outer edges of each sector may be somewhat better than the conventional linear array. However, the antenna beams generated by the twin-beam antenna array have significantly reduced performance in the boresight pointing direction of the antenna. As shown in FIG. 2C, a conventional tri-beam antenna array generates three even narrower antenna beams (per polarization), and provides good coverage in the boresight pointing direction of the antenna and throughout much of each sector, with some reduction in performance at the outer side edges of each sector and in between adjacent antenna beams.

The amount of data carried over cellular communications networks is increasing at a rate of about 20%-30% per year. This rapid increase in network usage has required that cellular network operators expand the number of base stations in their networks, and to also increase the capacity of existing base stations. Adding new base stations to a cellular network can be both time-consuming and expensive. A cellular operator must gain access to a physical site that is at an appropriate location for the base station, arrange to have sufficient electric power resources available at the site to power the base station electronics (e.g., radios, baseband equipment, etc.), provide enclosures (e.g., buildings or environmentally sealed cabinets or boxes) for the equipment, mount antennas in appropriate locations (preferably raised locations, which may require the installations of towers or poles), and obtain necessary permitting from local authorities. It often takes over a year to bring a new macro cell base station into a cellular network. While small cell base stations can typically be added to a cellular network more quickly (as they have much smaller power requirements and are often mounted on existing utility poles), they can still take months to install and they add significantly less capacity to the cellular network.

Upgrading existing base stations is typically less expensive than adding new base stations to a cellular network. Accordingly, cellular operators routinely replace cellular equipment at existing base stations (e.g., cellular radios and base station antennas) with newer equipment that supports higher data throughput. Cellular operators also add new equipment to existing base station antennas, such as equipment that operates in frequency bands not previously served by the base station.

One way of increasing the capacity of an existing base station is to replace sector antennas at the base station with sector-splitting antennas. Sector-splitting antennas are antennas that include at least one antenna array that sub-divides a sector into smaller sub-sectors by generating multiple antenna beams (per polarization) that provide service to each sub-sector. Since the sub-sectors are smaller than a sector, the generated antenna beams have narrower beamwidths in the azimuth plane, which acts to concentrate the RF energy, and hence have higher gain and can support higher data throughput.

Unfortunately, many existing base stations have limited electric power resources available. When, for example, a base station antenna that has linear arrays of radiating elements that are configured to form sector antenna beams is replaced with a base station antenna that has a tri-beam antenna array, it becomes necessary to add two more cellular radios to the base station. Modern cellular radios have high power requirements, and in many cases, an existing base station will not have sufficient DC power resources available to power two additional radios. It is both expensive and highly time-consuming to increase the power capabilities at an existing base station. Consequently, if sufficient DC power resources to power two additional radios are not available, a cellular operator may choose not to upgrade to a base station antenna having a tri-beam antenna array and instead will often deploy a twin-beam antenna, which only requires one additional radio for which sufficient power resources may be available.

The present invention is based, in part, on the realization that twin beam antennas are not well-suited for many cellular applications. In particular, there are a number of situations where a cellular operator will know that the majority of the users served by a base station antenna will tend to be in the middle of the sector served by the base station antenna. For example, base station antennas are often provided outside of large venues such as stadiums, coliseums, concert halls and the like. These base station antennas are typically pointed toward the venue so that most of the users are close to the boresight pointing direction of the antenna. As another example, base station antennas are often positioned to provide service to long, straight stretches of highways in rural areas. Most of the users of such base station antennas may be in cars on the highway, and hence two base station antennas may be mounted back-to-back to provide coverage along the highway. In these applications, the base station antennas are typically “aimed” at the desired coverage areas (i.e., the venue or the highway) so that the desired coverage areas are along or near the boresight pointing direction of the base station antennas. This ensures that the desired coverage area is within a high gain portion of the sector antenna beams that are generated by the base station antennas, since sector antenna beams typically have their highest gain along the boresight pointing direction of the antenna.

As noted above, one way of increasing the capacity of a base station is to replace existing base station antennas with base station antennas that perform sector-splitting in one or more frequency bands. Twin-beam antennas are the most commonly used sector-splitting base station antennas. While the use of twin-beam antennas can significantly increase the capacity supported by a base station, one disadvantage of twin-beam antennas is that the generated antenna beams typically have pointing directions (i.e., the direction where the antenna beams have peak gain) in the azimuth plane that are about +/-30 degrees from the boresight pointing direction in the azimuth plane. As such, the gain of a twin-beam antenna array along the boresight pointing direction of the antenna is typically about 6-9 dB below the peak gain of the antenna beams. As such, a twin beam antenna will typically have lower antenna gain in the boresight pointing direction than a comparable sector antenna, despite generating antenna beams that have higher peak gains. Consequently, twin-beam antennas are typically unsuitable for applications in which the users are more concentrated near the center of the sector since these users will be positioned in the gap between the two antenna beams where the antenna gain is low. In addition, twin beam antennas tend to have reduced stability as a function of frequency, with the pointing directions of the two antenna beams and the azimuth half power beamwidths of the two antenna beam exhibiting a relatively high amount of variation across the operating frequency band. This can result in deteriorated coverage (i.e., certain regions in the sector may have poor coverage at certain frequencies).

Tri-beam antennas have good gain along the boresight pointing direction, and hence can be used in applications that require good performance along the boresight pointing direction. Tri-beam antennas also have higher gain than corresponding twin-beam antennas (since they generate narrower, higher gain antenna beams), and tend to exhibit better stability as a function of frequency. Thus, tri-beam antennas provide both improved capacity and coverage as compared to twin-beam antennas.

Many cellular operators are deploying base station antennas that perform tri-beam sector-splitting in the mid-band frequency band. These antennas often include sixteen or twenty RF ports. For example, a modern 16-port sector-splitting antenna may include two tri-beam multi-column arrays of mid-band radiating elements, and hence can support 4T/4R MIMO communications in each of three sub-sectors (through twelve RF ports), along with two non-sector-splitting low-band linear arrays of radiating elements that support 4T/4R MIMO communications at low-band (through an additional four RF ports). A 20-port sector-splitting antenna may include the same arrays as the above-described 16-port antenna as well as two additional non-sector-splitting mid-band linear arrays of radiating elements (e.g., arrays that operate in the 1400 MHz frequency band). The above-described 16-port antennas, however, require three separate four-port radios to generate the RF signals that are supplied to the two tri-beam multi-column arrays, along with a fourth four-port radio that is coupled to the two low-band linear arrays (to support 4T/4R MIMO communications at low-band), while the 20-port antennas require the same four radios as well as a fifth four-port radio that is coupled to the two mid-band linear arrays (to support 4T/4R MIMO communications in the 1400 MHz frequency band). Each radio may, for example, support 480 Watts of output power, and hence have high DC power requirements.

While a new base station can be designed to have the necessary power resources available, existing base stations often have limited power resources. In many cases, existing base stations were constructed with sector base station antennas and hence had substantially less power resources available. These base stations often do not have sufficient DC power available to support the above described 16-port and 20-port sector-splitting antennas. Since it typically is both very expensive and time-consuming to upgrade the power resources at an existing power station (as such an upgrade typically requires local government permitting and coordination with local power companies), cellular operators typically either add a new base station to the network or upgrade the existing base station to employ twin-beam sector splitting antennas (assuming that sufficient power resources are available to support the twin-beam antennas) instead of upgrading the power resources at the base station and employing tri-beam antennas.

Pursuant to some embodiments of the present invention, cellular base stations and related methods of operating cellular base stations are provided in which a multi-beam antenna is provided that is operated using radios that have different maximum output power levels. As one example, a base station may employ a base station antenna having a tri-beam array of mid-band radiating elements that is coupled to three two-port radios (or two tri-beam arrays of mid-band radiating elements that are coupled to three four-port radios), where one of the radios has a higher maximum output power level than at least one of the other radios. As another example, the base station may instead have a base station antenna that has a tri-beam array of mid-band radiating elements that is coupled to three two-port radios (or two tri-beam arrays of mid-band radiating elements that are coupled to three four-port radios) along with a power distribution system that is configured to supply up to a first maximum amount of power to a first of the radios and to supply up to a second maximum amount of power to a second of the radios that is greater than the first maximum amount of power.

As described above, in many applications, the average number of users within the center third of a sector (in the azimuth plane) served by a base station antenna may be significantly larger than the average number of users in the outer two thirds of the sector. In such a situation, very little reduction in performance may be experienced if lower power radios are used to generate the two outer mid-band antenna beams formed by a tri-beam antenna array. For example, a 480 Watt radio (i.e., a cellular radio that has a 480 Watt maximum output power level) may be used to form the center of the three mid-band antenna beams and two 240 Watt or 300 Watt radios may be used to form the two outer mid-band antenna beams. In fact, due to the increased antenna gain provided by the tri-beam antenna, the peak RF power levels of each outer antenna beam may be within 3-4 dB of the peak RF power levels of the two beams generated by a twin-beam antenna array. Moreover, the peak RF power level of the inner beam generated by the tri-beam antenna may be significantly higher than the RF power levels provided by a twin beam antenna array to users in the center of the sector since the inner beam generated by the tri-beam antenna array is narrower than a comparable twin beam antenna beam (and hence has higher gain) and because the inner beam is directed in the boresight pointing direction of the antenna such that the users in the center of the sector are mostly within the 3 dB azimuth beamwidth of the antenna beam, whereas with a twin-beam antenna most of the users would be within a null. As a result, RF power levels for users in the center of the sector may, for example, be 3-12 dB higher when a tri-beam antenna array is used in the manner disclosed herein instead of a twin-beam antenna array. This may result in a significant overall increase in the capacity supported by the base station.

The base stations according to embodiments of the present invention that employ tri-beam antenna arrays that use lower power radios for the outer beams may provide increased capacity and improved coverage as compared to a base station antenna that employed a comparable twin-beam antenna array. This improved performance may be achieved while using the same amount of power resources. In addition, the base stations according to embodiments of the present invention may exhibit improved inter-sector and intra-sector interference since the narrower antenna beams generated by the tri-beam antenna array tend to have less RF energy spillover into adjacent sectors. Moreover, the use of a tri-beam antenna array allows for independent downtilt control on all three antenna beams (as compared to independent downtilt control on two antenna beams for a twin-beam antenna), which provides greater flexibility to a cellular operator to adjust the size of each sub-sector based on the locations of adjacent base stations, terrain features and the like. Finally, the base stations according to embodiments of the present invention will already include base station antennas having tri-beam antenna arrays and hence can be further upgraded in the future by adding additional power generation capacity.

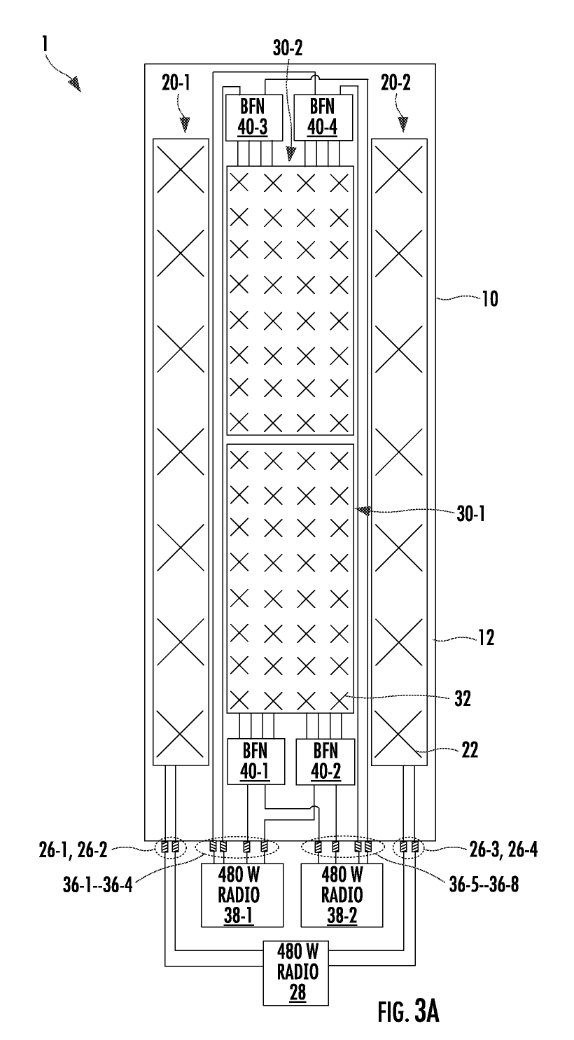

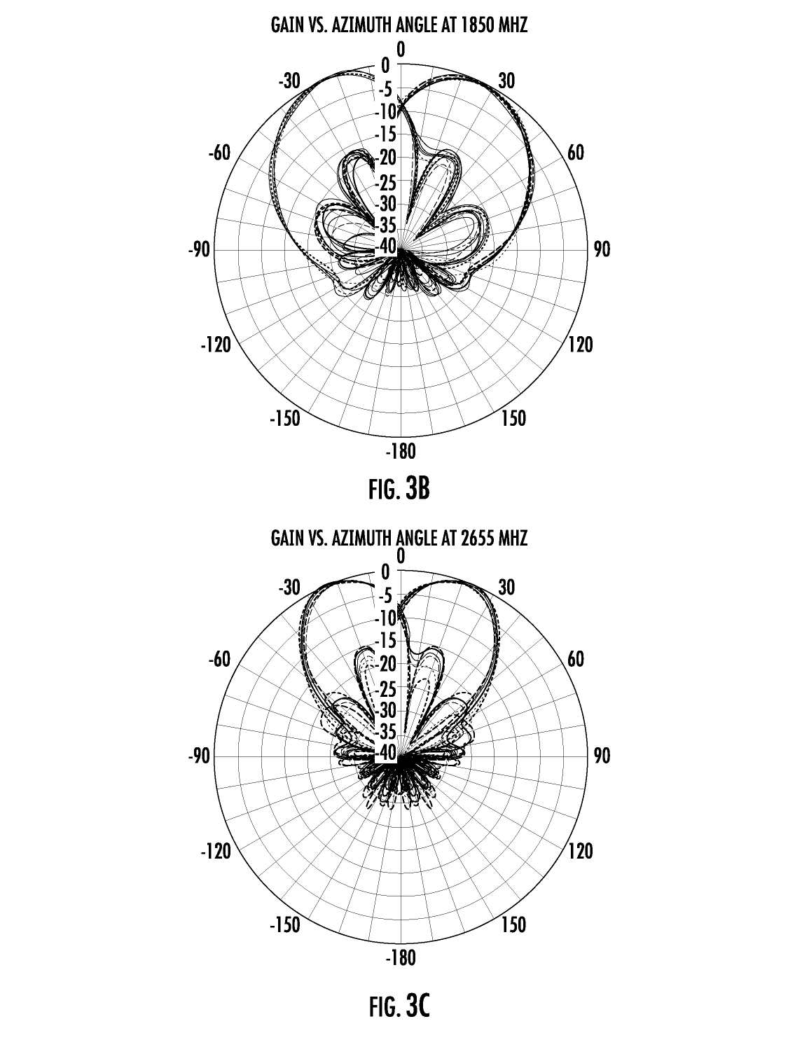

Example embodiments of the present invention will now be discussed in greater detail with reference to FIGS. 3A-7.

FIG. 3A is a schematic block diagram of some of the equipment for one sector of a conventional three-sector base station 1. The conventional base station 1 includes a multi-band base station antenna 10, a four-port low-band radio 28, and first and second four-port mid-band radios 38-1, 38-2. It will be appreciated that the sector of the conventional three-sector base station 1 will include further equipment that is not shown in FIG. 3A including, for example, baseband equipment that is coupled to each radio 28, 38, AC and DC power equipment, back-up batteries, backhaul communications equipment and the like.

As shown in FIG. 3A, multi-band base station antenna 10 includes a reflector 12, two linear arrays 20-1, 20-2 of low-band radiating elements 22, and two multi-column arrays 30-1, 30-2 of mid-band radiating elements 32. Each multi-column arrays 30-1, 30-2 includes four columns of mid-band radiating elements 32, although it will be appreciated that other numbers of columns may be used. The radiating elements 22, 32 of the four antenna arrays 20-1, 20-2, 30-1, 30-2 are mounted forwardly of the reflector 12. The antenna 10 further includes four low-band RF ports 26-1 through 26-4 that may be connected, for example, to the radio ports of the 4-port low-band radio 28 via coaxial cables or the like. The first low-band RF port 26-1 is coupled to the -45⁰ radiators of the dual-polarized radiating elements 22 in the first low-band linear array 20-1 by a first feed network, the second low-band RF port 26-2 is coupled to the +45⁰ radiators of the dual-polarized radiating elements 22 in the first low-band linear array 20-1 by a second feed network, the third low-band RF port 26-3 is coupled to the -45⁰ radiators of the dual-polarized radiating elements 22 in the second low-band linear array 20-2 by a third feed network, and the fourth low-band RF port 26-4 is coupled to the +45⁰ radiators of the dual-polarized radiating elements 22 in the second low-band linear array 20-2 by a fourth feed network. The above-described feed networks are shown schematically by respective lines connecting each RF port 26, 36 to its associated array 20, 30 to simplify the figure.

The antenna 10 further includes first through eighth mid-band RF ports 36-1 through 36-8 and first through fourth beamforming networks 40-1 through 40-4. The first through fourth mid-band RF ports 36-1 through 36-4 may be connected, for example, to the radio ports of the first 4-port mid-band radio 38-1, and the fifth through eighth mid-band RF ports 36-5 through 36-8 may be connected, for example, to the radio ports of the second 4-port mid-band radio 38-2. The mid-band RF ports 36 may be connected to the radio ports via coaxial cables or the like.

Each beamforming network 40 includes two inputs and four outputs. The two inputs of the first beamforming network 40-1 are coupled to the third and fifth mid-band RF ports 36-3, 36-5, the two inputs of the second beamforming network 40-2 are coupled to the fourth and sixth mid-band RF ports 36-4, 36-6, the two inputs of the third beamforming network 140-3 are coupled to the second and eighth mid-band RF ports 36-2, 36-8, and the two inputs of the fourth beamforming network 40-4 are coupled to the first and seventh mid-band RF ports 36-1, 36-7. Each beamforming network 40 may comprise, for example, a Butler Matrix based beamforming network that includes a plurality of combiners (e.g., four-port combiners) and/or phase shift elements. Butler Matrix based beamforming networks are well known in the art and hence further description thereof will be omitted here.

The four outputs of the first beamforming network 40-1 are coupled to the -45⁰ radiators of the dual-polarized radiating elements 32 in the respective four columns of the first multi-column array 30-1, the four outputs of the second beamforming network 40-2 are coupled to the +45⁰ radiators of the dual-polarized radiating elements 32 in the respective four columns of the first multi-column array 30-1, the four outputs of the third beamforming network 40-3 are coupled to the -45⁰ radiators of the dual-polarized radiating elements 32 in the respective four columns of the second multi-column array 30-2, and the four outputs of the fourth beamforming network 40-4 are coupled to the +45⁰ radiators of the dual-polarized radiating elements 32 in the respective four columns of the second multi-column array 30-2.

The base station antenna 1 of FIG. 3A may operate as follows. Four low-band RF signals that are output from the four ports of the low-band radio 28 are input to the respective low-band RF ports 26-1 through 26-4 of base station antenna 10 and passed by the low-band feed networks to the two low-band linear arrays 20-1, 20-2. The low-band linear arrays 20-1, 20-2 generate four sector antenna beams in response to these low-band signals that each provide coverage to the full sector served by base station antenna 10. The low-band radio 28 may be a 4T/4R radio.

Four mid-band RF signals that are output from the four ports of the first mid-band radio 38-1 are input to the respective mid-band RF ports 36-1 through 36-4, with each of these RF signals being passed to a respective one of the four beamforming networks 40-1 through 40-4. Four mid-band RF signals that are output from the four ports of the second mid-band radio 38-2 are input to the respective mid-band RF ports 36-5 through 36-8, with each of these RF signals also being passed to a respective one of the four beamforming networks 40-1 through 40-4 so that each beamforming network receives two RF signals. Each beamforming network 40 splits the two RF signals input thereto into a plurality of sub-components, and the sub-components of the two RF signals are combined (and potentially phase-shifted) in a predetermined manner. Respective sub-sets of the combined and phase-shifted sub-components are output through the four outputs of the respective beamforming networks 40-1 through 40-4 and passed to the radiating elements 32 in the respective first through fourth columns of either the first twin-beam mid-band antenna array 30-1 or the second twin-beam mid-band antenna array 30-2. Each beamforming network 40 is configured so that the sub-components of the two RF signals that are output therefrom will generate a pair of antenna beams that point in two different directions, as shown in FIG. 2B above. In other words, a total of eight antenna beans are generated so that base station antenna 10 can support 4T/4R MIMO communications in two different frequency ranges within the mid-band operating frequency range.

FIGS. 3B and 3C are polar graphs of the radiation patterns as a function of azimuth pointing angle for the twin-beam mid-band antenna arrays of the conventional multi-band base station antenna 10 of FIG. 3A, where FIGS. 3B and 3C show the antenna gain (normalized to the maximum gain) at the 1850 MHz (1710-1880 MHZ) and 2655 MHz (2500-2690 MHZ) sub-bands of the mid-band frequency band, respectively. It will be appreciated that FIGS. 3B and 3C show the antenna pattern for the first polarization antenna beams generated by the antenna arrays. The second polarization antenna beams will typically be nearly identical to the first polarization antenna beams and hence are not separately depicted.

As shown in FIGS. 3B and 3C, the two (first polarization) antenna beams generated by the twin beam antenna array have azimuth pointing directions of about +/-29⁰ (at 1850 MHz) or about +/-21⁰ (at 2655 MHz). Since the center of the main lobes of the antenna beams are offset from the boresight pointing direction, the gain of each antenna beam in the boresight pointing direction is significantly reduced. In the example shown in FIGS. 3B-3C, the gain of each antenna beam in the boresight pointing direction is about 10 dB below peak gain at 1850 MHz and about 7-8 dB below peak gain at 2655 MHz. This means that the twin-beam antenna arrays can only support limited capacity with respect to users that are close to the boresight pointing direction of the antenna. In addition, the azimuth beamwidth of each antenna beam becomes very large in the lower portion of the mid-band frequency band (see FIG. 3B), which results in a significant amount of spillover into neighboring sectors (i.e., a significant amount of RF energy is directed at azimuth angles outside the -60 degree to 60 degree range). The azimuth pointing direction of the two beam peaks also vary significantly with frequency, showing a variation of about 8 degrees between FIGS. 3B and 3C. This tends to be a contributing factor in the large amount of spillover of RF energy outside of the sector at lower frequencies.

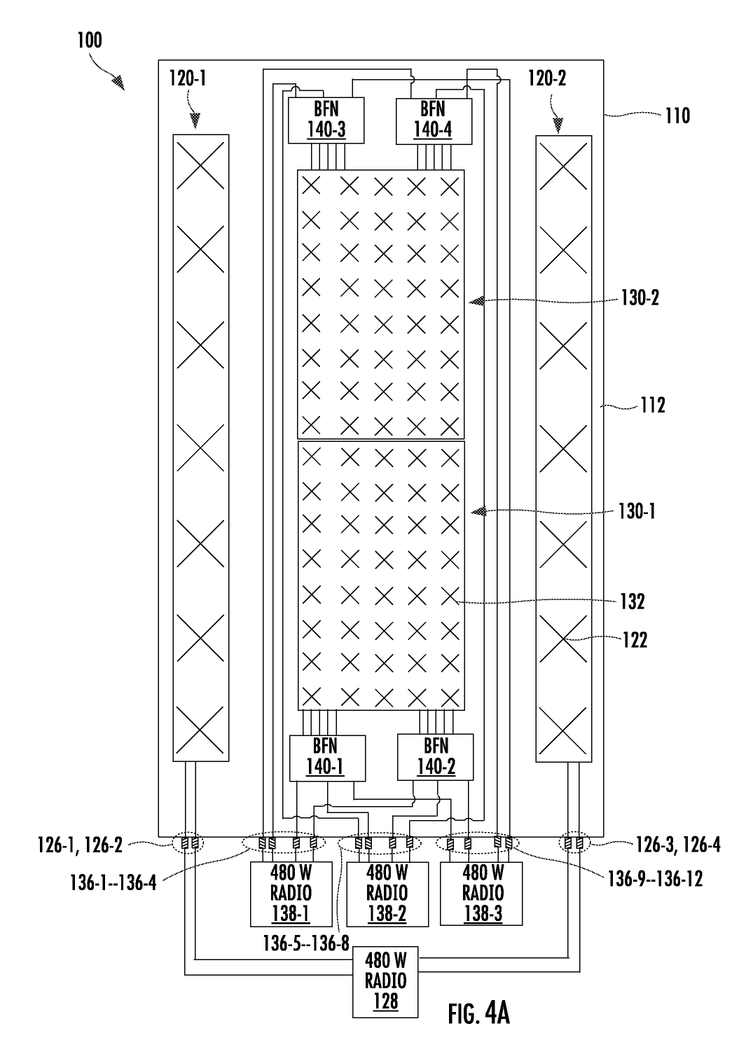

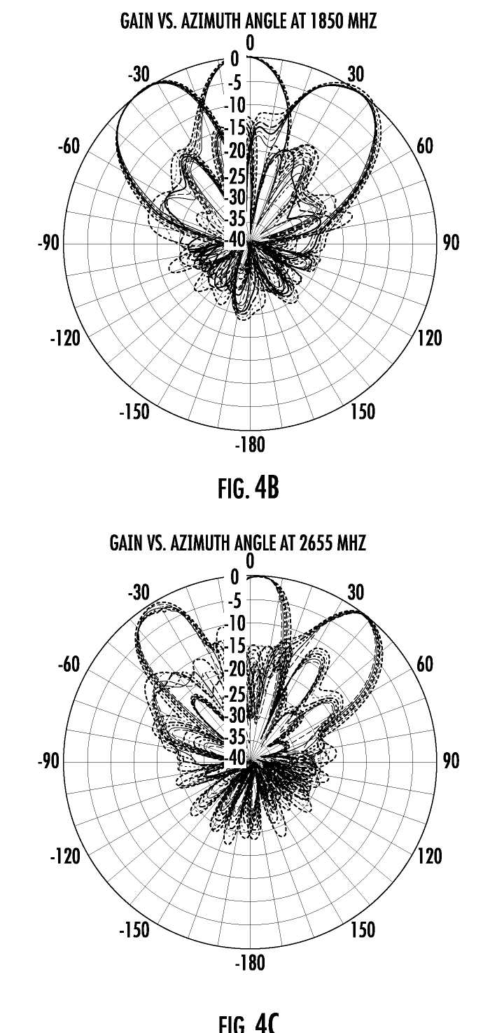

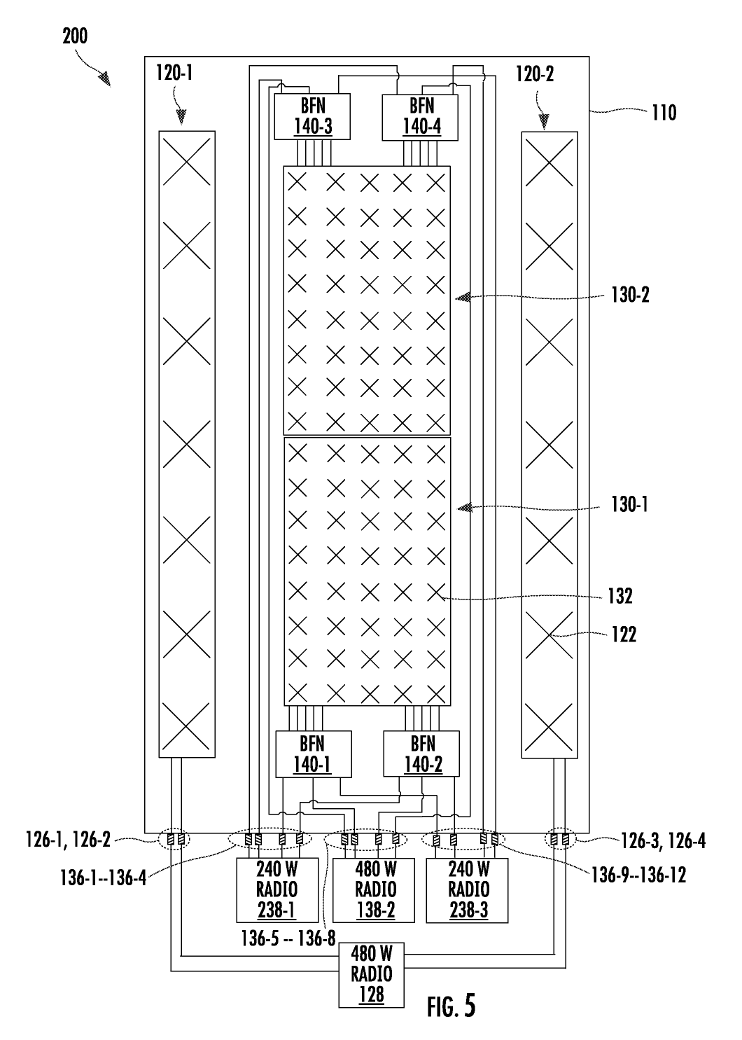

FIG. 4A is a schematic block diagram of some of the equipment for one sector of another conventional three-sector base station 100. The conventional base station 100 includes a multi-band base station antenna 110, a four-port low-band radio 128, and first through third four-port mid-band radios 138-1 through 138-3. It will be appreciated that the sector of the conventional three-sector base station 100 will include further equipment that is not shown in FIG. 4A including, for example, baseband equipment that is coupled to each radio 128, 138, AC and DC power equipment, back-up batteries, backhaul communications equipment and the like.

As shown in FIG. 4A, multi-band base station antenna 110 includes a reflector 112, two linear arrays 120-1, 120-2 of low-band radiating elements 122, and two multi-column arrays 130-1, 130-2 of mid-band radiating elements 132. (The low-band and mid-band radiating elements 122, 132 are each implemented as dual-polarized radiating elements, as illustrated by the "X" shape in the figure, indicating that each radiating element 122, 132 has first and second radiators). Each multi-column array 130-1, 130-2 includes five columns of mid-band radiating elements 132, although it will be appreciated that other numbers of columns (e.g., four or six columns) may be included in each array 130. The radiating elements 122, 132 of the four antenna arrays 120-1, 120-2, 130-1, 130-2 are mounted forwardly of the reflector 112.

The antenna 110 further includes four low-band RF ports 126-1 through 126-4 that may be connected, for example, to the radio ports of a 4-port low-band radio 128 via coaxial cables or the like. The first low-band RF port 126-1 is coupled to the -45⁰ radiators of the dual- polarized radiating elements 122 in the first low-band linear array 120-1, the second low-band RF port 126-2 is coupled to the +45⁰ radiators of the dual-polarized radiating elements 122 in the first low-band linear array 120-1, the third low-band RF port 126-3 is coupled to the -45⁰ radiators of the dual-polarized radiating elements 122 in the second low-band linear array 120-2, and the fourth low-band RF port 126-4 is coupled to the +45⁰ radiators of the dual-polarized radiating elements 122 in the second low-band linear array 120-2.

Base station antenna 110 further includes first through twelfth mid-band RF ports 136-1 through 136-12 and first through fourth beamforming networks 140-1 through 140-4. The first through fourth mid-band RF ports 136-1 through 136-4 may be connected, for example, to the radio ports of a first 4-port mid-band radio 138-1, the fifth through eighth mid-band RF ports 136-5 through 136-8 may be connected, for example, to the radio ports of a second 4-port mid-band radio 138-2, and the ninth through twelfth mid-band RF ports 136-9 through 136-12 may be connected, for example, to the radio ports of a third 4-port mid-band radio 138-3.

The beamforming networks 140 may be implemented in a variety of different ways that are known in the art, and may have, for example, a Butler Matrix, a Blass Matrix or a Nolen Matrix configuration. Each beamforming network 140 includes three inputs and five outputs. The three inputs of the first beamforming network 140-1 are coupled to the third, sixth and ninth mid-band RF ports 136-3, 136-6, 136-9, the three inputs of the second beamforming network 140-2 are coupled to the fourth, seventh and tenth mid-band RF ports 136-4, 136-7, 136-10, the three inputs of the third beamforming network 140-3 are coupled to the second, fifth and twelfth mid-band RF ports 136-2, 136-5, 136-12, and the three inputs of the fourth beamforming network 140-4 are coupled to the first, eighth and eleventh mid-band RF ports 136-1, 136-8, 136-11.

The five outputs of the first beamforming network 140-1 are coupled to the -45⁰ radiators of the dual-polarized radiating elements 132 in the respective five columns of the first multi-column array 130-1, the five outputs of the second beamforming network 140-2 are coupled to the +45⁰ radiators of the dual-polarized radiating elements 132 in the respective five columns of the first multi-column array 130-1, the five outputs of the third beamforming network 140-3 are coupled to the -45⁰ radiators of the dual-polarized radiating elements 132 in the respective five columns of the second multi-column array 130-2, and the five outputs of the fourth beamforming network 140-4 are coupled to the +45⁰ radiators of the dual-polarized radiating elements 132 in the respective five columns of the second multi-column array 130-2.

The low-band linear arrays of base station antenna 110 may operate in the exact same manner as the low-band linear arrays of base station antenna 10, and hence further description thereof will be omitted. The two five-column arrays 130-1, 130-2 of mid-band radiating elements 132 may operate in a similar fashion to the two four-column arrays 30-1, 30-2 of base station antenna 10, except that the five-column arrays 130-1, 130-2 of base station antenna 110 operate as tri-beam antenna arrays that each generate three relatively narrow antenna beams (at each polarization) that provide service to respective 40⁰ sub-sectors in the azimuth plane. Thus, further description of the operation of the five column arrays 130-1, 130-2 of base station antenna 110 will also be omitted.

It will be appreciated that base station antenna 110 will include various other components that are not shown in FIG. 4A including, for example, one or more of a protective radome, top and/or bottom end caps, remote electronic tilt systems (e.g., DC motors, mechanical linkages and electromechanical phase shifters) that can be used to impart an electronic downtilt to the generated antenna beams using techniques that are well understood in the art, diplexers, cables, parasitic elements for further shaping the generated antenna beams, etc. These structures are omitted from FIG. 4A and the other figures to focus on various unique aspects of the multi-beam base station antennas according to the various example embodiments of the present invention.

FIGS. 4B and 4C are polar graphs of the radiation patterns as a function of azimuth pointing angle for the first polarization antenna beams generated by one of the tri-beam mid-band antenna arrays of base station antenna 110 for RF excitation signals in the 1850 MHz and 2655 MHz frequency bands.

As shown in FIGS. 4B and 4C, the three (first polarization) antenna beams generated by the first tri-beam mid-band antenna array 130-1 have azimuth pointing directions of about -35⁰, 0⁰ and +35⁰ (at 1850 MHz) or about -39⁰, 0⁰ and +39⁰ (at 2655 MHz). Since the center or "inner" antenna beam has its peak gain along the boresight pointing direction, base station antenna 110 may provide excellent service to users located in the center of the sector. In addition, the azimuth beamwidths of the antenna beams are considerably less than their twin-beam counterparts, and hence there is significantly less spillover of RF energy into neighboring sectors, even in the lower portion of the mid-band frequency band. The azimuth pointing directions of the outer beam peaks also show less variation (here about 4⁰) with frequency than their twin beam counterparts. In addition to the above advantages, the three antenna beams shown in FIGS. 4B and 4C each have higher peak gains as compared to the counterpart beams shown in FIGS. 3B and 3C that are generated by the twin-beam antenna array 30-1 of base station antenna 10.

As described above, in many cases, the amount of DC power available at a base station may be limited, either because the base station has limited AC power available, or because the AC-to-DC conversion equipment at the base station has limited capacity. As such, it may not be possible to power low-band radio 128 and all three mid-band radios 138-1 through 138-3 at their maximum power levels. Because of these power constraints, cellular operators will not upgrade such base stations to use the base station antenna 110 of FIG. 4A, but instead will upgrade such base stations by deploying base station antennas that have twin-beam arrays such as the base station antenna 10 of FIG. 3A. While such twin-beam base stations will typically increase the capacity supported by the base station, they have significant drawbacks when compared to the base station antenna 110 that includes tri-beam instead of twin-beam arrays, as the twin-beam arrays of base station 10 have poor gain performance along the boresight pointing direction of the antenna and generate increased interference into neighboring sectors due to spillover of the twin antenna beams into neighboring sectors, particularly when operating in the lower portion of the mid-band operating frequency band (see FIG. 3B above and the discussion thereof).

The present invention is based, in part, on the realization that base station antenna 110 can provide significantly better performance than base station 10, even if the radios providing service to the outer sub-sectors of the tri-beam mid-band antenna arrays are operated at lower power. For example, if the radios 138-1, 138-3 providing service to the outer sub-sectors of the tri-beam mid-band antenna arrays are operated at no more than half their maximum output power level, the energy usage of base station antenna 110 and its associated radios and baseband equipment may be approximately the same as the energy usage of base station antenna 10 and its associated radios and baseband equipment. However, the overall throughput supported by the mid-band arrays 130-1, 130-2 of base station antenna 110 with the radios providing service to the outer sub-sectors of the tri-beam mid-band antenna arrays operated at half their maximum output power levels will typically exceed the throughput supported by the mid-band arrays of base station antenna 10 with the mid-band radios operated at their full maximum output power. The increase in supportable throughput may be very large in applications where the majority of the mid-band users are located in the central portion of the sector, as these users are serviced by a high-gain antenna beam that is pointed in the boresight pointing direction of the antenna. In addition, base station antenna 110 may exhibit less spillover of RF energy into neighboring sectors, as the tri-beam antenna beams are better shaped to keep the RF energy within the sector and because the radios providing the RF signals corresponding to the outer antenna beams are operated at half power. While adding an extra mid-band radio 138 adds additional up-front costs, and mid-band base station antenna 110 will typically cost somewhat more than base station antenna 10, deploying the additional radios and base station antenna 110 makes the base station ready for future upgrades (e.g., if additional power resources are ultimately deployed to the base station).

FIG. 5 is a schematic block diagram of selected equipment of a sector of a base station 200 according to embodiments of the present invention that includes the base station antenna 110 of FIG. 4A and associated radios 128,238-1, 138-2, 238-3. As can be seen by comparing FIGS. 4 and 5, base station 200 is similar to base station 100, with the primary difference being that base station 100 includes three 480 Watt four-port mid-band radios 138-1 through 138-3, while base station 200 includes one 480 Watt four-port mid-band radio 138-2 that is used to generate the inner mid-band antenna beams and two 240 Watt four-port mid-band radios 238-1, 238-3 that are used to generate the outer mid-band antenna beams. Notably, the combined maximum output power of the radios of base station 200 is the same as the combined maximum output power of the radios of base station 1. Thus, if a base station has sufficient power resources to upgrade to the configuration of base station 1 of FIG. 3 (which includes a base station antenna 10 that has two mid-band twin-beam antenna arrays), it also has sufficient power resources to upgrade to the configuration of base station of FIG. 5. In many (if not all) applications, base station 200 will provide better performance than base station 1.

As shown in FIG. 5, pursuant to certain embodiments of the present invention, a cellular base station is provided that comprises a base station antenna 110, a first radio 138-1 and a second radio 138-2. The base station antenna 110 comprises a first set of RF ports 136-3, 136-6, 136-9 that has a total of N first polarization RF ports, where N is an integer that is greater than 2 (here N equals 3). The base station antenna 110 further comprises a first multi-column array 130-1 of radiating elements 132 that is configured to generate N first polarization antenna beams, the N first polarization antenna beams including a first pair of outer first polarization antenna beams and a first inner first polarization antenna beam, and a first beamforming network 140-1 that electrically connects the first set of RF ports 136-3, 136-6, 136-9 to the first multi-column array 130-1 of radiating elements 132. The first radio 138-1 has a first radio port that is coupled to a first 136-3 of the N first polarization RF ports in the first set of RF ports 136-3, 136-6, 136-9, the first radio 138-1 having a first maximum output power level (here 240 Watts). The second radio 138-2 has a first radio port that is coupled to a second 136-6 of the N first polarization RF ports in the first set of RF ports 136-3, 136-6, 136-9, the second radio 138-2 having a second maximum output power level (here 480 Watts) that is greater than the first maximum output power level.

A first RF signal that is output through the first radio port of the first radio 138-1 is configured to generate one of the outer first polarization antenna beams. A second RF signal that is output through the first radio port of the second radio 138-2 is configured to generate the first inner first polarization antenna beam. The second maximum output power level may be at least 20% larger, at least 30% larger, or at least 50% larger than the first maximum output power level.

The base station antenna 110 may further include a second set of RF ports 136-4, 136-7, 136-10 that has a total of N second polarization RF ports and a second beamforming network 140-2 that electrically connects the second set of RF ports 136-4, 136-7, 136-10 to the first multi-column array 130-1 of radiating elements 132. The first radio 138-1 has a second radio port that is coupled to a first of the N second polarization RF ports 136-4 in the second set of RF ports 136-4, 136-7, 136-10. The second radio 138-2 has a second radio port that is coupled to a second of the N second polarization RF ports 136-7 in the second set of RF ports 136-4, 136-7, 136-10.

The base station antenna 110 may also include a third set of RF ports 136-2, 136-5, 136-12 that has a total of N first polarization RF ports, a second multi-column array 130-2 of radiating elements 132 that is configured to generate a second set of N first polarization antenna beams, the second set of N first polarization antenna beams including a second pair of outer first polarization antenna beams and a second inner first polarization antenna beam, and a third beamforming network 140-3 that electrically connects the third set of RF ports 136-2, 136-5, 136-12 to the second multi-column array 130-2 of radiating elements 132. The first radio 138-1 has a third radio port that is coupled to a first of the N first polarization RF ports 136-2 in the third set of RF ports 136-2, 136-5, 136-12, and the second radio 138-2 has a third radio port that is coupled to a second of the N first polarization RF ports 138-5 in the third set of RF ports 136-2, 136-5, 136-12. The first radio 138-1 and the second radio 138-2 may each be 4-transmit/4-receive MIMO radios. The first multi-column array 130-1 of radiating elements may comprise mid-band radiating elements 132 that are configured to operate in at least a portion of a 1427-2690 MHz frequency band. Moreover, the base station antenna 110 may further comprise a first array 120-1 of radiating elements 122 that are configured to operate in at least a portion of a 616-960 MHz frequency band and a second array 120-2 of radiating elements 122 that are configured to operate in at least a portion of the 616-960 MHz frequency band.

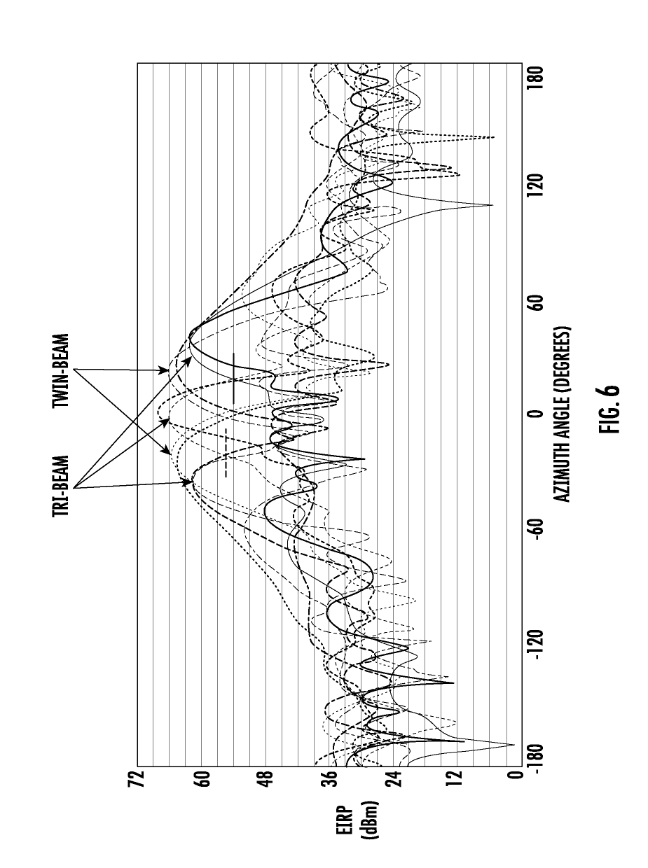

FIG. 6 is a graph of the effective isotropic radiated power ("EIRP") as a function of azimuth pointing angle for the mid-band antenna beams generated by conventional base station 1 of FIG. 3 that includes twin-beam mid-band antenna arrays and for the mid-band antenna beams generated by the base station 200 of FIG. 5 that includes tri-beam mid-band antenna arrays that are connected to two 240 W radios (for the outer antenna beams) and to one 480 W radio (for the inner beam). As can be seen from FIG. 6, peak EIRP of the mid-band antenna beams generated by the twin-beam base station antenna 10 of FIG. 3 is about 4.5 dB higher than the peak EIRP of the outer antenna beams generated by the tri-beam base station antenna 200 of FIG. 5. However, the EIRP of along the boresight pointing direction of tri-beam base station antenna 200 is about 11 dB higher than the EIRP of along the boresight pointing direction of twin-beam base station antenna 1. This increase in EIRP along the boresight pointing direction will typically have a much greater favorable impact on capacity than the reduction in the peak EIRP of the outer antenna beams. Thus, base station antenna 200 will typically support higher throughputs than base station antenna 1, and this is particularly true in applications where the users are primarily in the center of the sector.

It is anticipated that base station 200 of FIG. 5 will support at least a 40% increase in data throughput as compared to base station 1 of FIG. 3, with a capacity gain of at least 60%. In addition, a cellular operator can upgrade a base station in the manner described herein to achieve an initial increase in capacity and may then (or later) take the necessary steps to upgrade the power resources available at the base station. This can take months or even years due to government permitting requirements and the necessity of involvement by local utility companies. Since the cellular operator will have already upgraded the base station to include base station antennas with tri-beam antenna arrays and extra radios, once the power resource upgrade is complete, the base station may achieve a further capacity upgrade without any additional changes required.

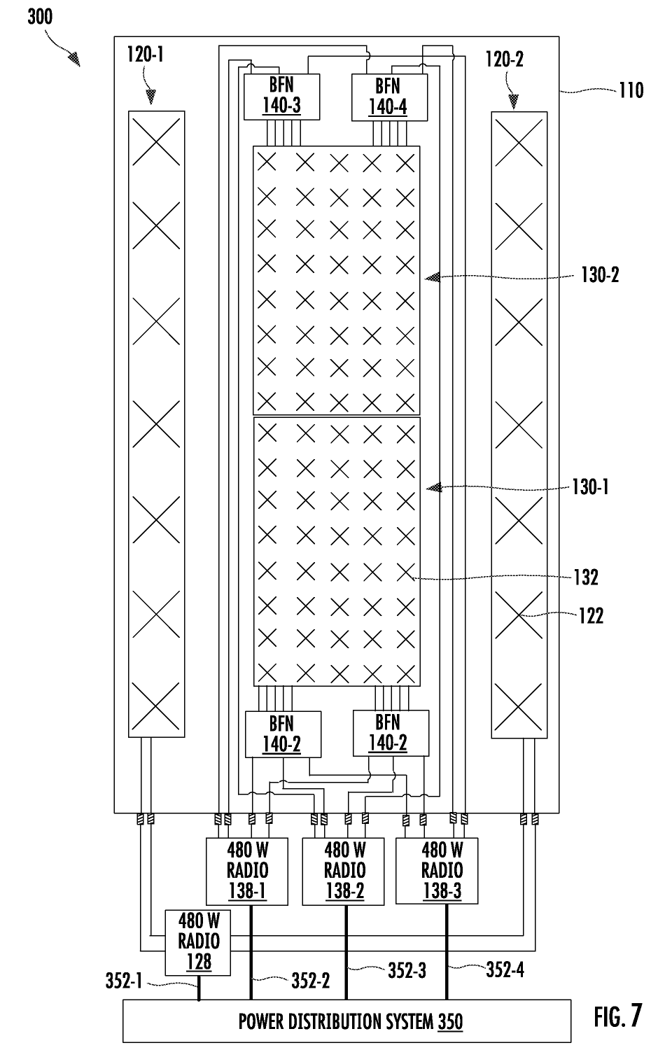

FIG. 7 is a schematic block diagram of some of the equipment for one sector of a three-sector base station 300 according to further embodiments of the present invention. As can be seen by comparing FIGS. 4A and 7, base station 300 may be identical to base station 100 except that base station 300 further includes a power distribution system 350 that supplies DC power to each of the radios 128, 138. The power distribution system 350 may be coupled to an AC power source (not shown). As shown in FIG. 7, the power distribution system 350 has a plurality of outputs 352-1 through 352-4 that are connected to the respective radios 128, 138-1, 138-2, 138-3. The power distribution system 350 may be configured to determine a maximum amount of DC power that may be output through each of the outputs 352-1 through 352-4. For example, the power distribution system 350 may be configured to deliver up to 480 Watts through each of outputs 352-1 and 352-3, but to only deliver up to 240 Watts through each of outputs 352-2 and 352-4. FIG. 7 shows that a base station may be upgraded to have full power radios associated for all of the antenna beams generated by a multi-beam antenna array, even if the base station does not have sufficient power resources to power all of these radios at full power. The power distribution system 350 may be used to control how the available power is divided between the radios, allowing base station 300 to operate in the exact same manner as base station 200 of FIG. 5. If base station 300 is later upgraded to have additional power resources, the power distribution system may be set to deliver sufficient power to each radio 128, 138-1, 138-2, 138-3 so that they all may operate at their maximum output power levels.

It will also be appreciated that the settings of power distribution system 350 may be changed. For example during some periods of time it may be beneficial to provide the same amount of power top each of the mid-band radios 138-1 through 138-3. Assuming, for example, that the amount of DC power available is sufficient to power mid-band radios 138-1 through 138-3 that have a combined maximum output power level of 960 Watts, then the power distribution system 350 may be set during these time periods to output one-third of the available power to each of the 138-1 through 138-3.

As shown in FIG. 7, pursuant to additional embodiments of the present invention, a cellular base station 300 is provided that comprise a base station antenna 110 that comprises a first beamforming network 140-1 that is coupled to a sector-splitting antenna array 130-1, the first beamforming network 140-1 and the sector-splitting antenna array 130-1 configured to generate at least three first polarization antenna beams in response to respective first, second and third RF signals. The base station 300 further includes a first radio 138-1, a second radio 138-2 and a third radio 138-3 that are coupled to the first beamforming network 140-1, and a power distribution system 350 that is configured to supply up to a first maximum amount of power to the first radio 138-1 and to supply up to a second maximum amount of power to the second radio 138-2 that is greater than the first maximum amount of power.

The power distribution system 350 may also be configured to supply up to a third maximum amount of power to the third radio 138-3, where the third maximum amount of power is less than the second maximum amount of power. The base station antenna 110 may further comprise a second beamforming network 140-2 that is also coupled to the sector-splitting antenna array 130-1, the second beamforming network 140-2 and the sector-splitting antenna array 130-1 configured to generate at least three second polarization antenna beams. The first polarization antenna beams may, for example, have a -45 degree slant polarization and the second polarization antenna beams may, for example, have a +45 degree slant polarization.

The first polarization antenna beams may comprise a first pair of outer first polarization antenna beams and a first inner antenna beam that is positioned in between the antenna beams of the first pair of antenna beams. In such embodiments, the second radio 138-2 is coupled to an input of the first beamforming network 140-1 that corresponds to the first inner antenna beam. A high seating capacity venue such as a stadium or a coliseum may be within a sector served by the base station antenna 110 and the high seating capacity venue may be within a main lobe of the first inner antenna beam. The second maximum amount of power may be at least 30% larger than the first maximum amount of power.

The first radio 138-1 may be coupled to a first output of the power distribution system 350 and the second radio 138-2 may be coupled to a second output of the power distribution system 350, and the power distribution system 350 is configured to supply up to a first maximum amount of DC power to the first output of the power distribution system 350 and up to a second maximum amount of DC power to the second output of the power distribution system 350, where the second maximum amount of DC power is at least 30% greater than the first maximum amount of DC power.

While the above embodiment focus on base station antennas that have tri-beam antenna arrays, it will be appreciated that embodiments of the present invention are not limited thereto. Instead, the techniques disclosed herein may be used with any multi-beam antenna array that generated three of more antenna beams per polarization. It will also be appreciated that the radios that receive the higher power levels need not always be the radios that generated the RF signals that correspond to the outer antenna beams. Instead, any of the antenna beams may be coupled to the lower power radios depending on actual needs.

It will be appreciated that the present specification only describes a few example embodiments of the present invention and that the techniques described herein have applicability beyond the example embodiments described above.

The description above primarily uses language that describes the transmit paths through the base station antennas (i.e., the paths of RF signals that are transmitted by the base station antennas). It will be appreciated that base station antennas include bi-directional RF signal paths, and that the base station antennas will also be used to receive RF signals. In the receive path, RF signals will typically be combined whereas the RF signals are split in the transmit path. Thus, it will be apparent to the skilled artisan that the base station antennas described herein may be used to receive RF signals.

Embodiments of the present invention have been described above with reference to the accompanying drawings, in which embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Like numbers refer to like elements throughout.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the present invention. As used herein, the term "and/or" includes any and all combinations of one or more of the associated listed items.

It will be understood that when an element is referred to as being "on" another element, it can be directly on the other element or intervening elements may also be present. In contrast, when an element is referred to as being "directly on" another element, there are no intervening elements present. It will also be understood that when an element is referred to as being "connected" or "coupled" to another element, it can be directly connected or coupled to the other element or intervening elements may be present. In contrast, when an element is referred to as being "directly connected" or "directly coupled" to another element, there are no intervening elements present. Other words used to describe the relationship between elements should be interpreted in a like fashion (i.e., "between" versus "directly between", "adjacent" versus "directly adjacent", etc.).

The terminology used herein is for the purpose of describing particular embodiments only and is not intended to be limiting of the invention. As used herein, the singular forms "a", "an" and "the" are intended to include the plural forms as well, unless the context clearly indicates otherwise. It will be further understood that the terms "comprises" "comprising," "includes" and/or "including" when used herein, specify the presence of stated features, operations, elements, and/or components, but do not preclude the presence or addition of one or more other features, operations, elements, components, and/or groups thereof.

Aspects and elements of all of the embodiments disclosed above can be combined in any way and/or combination with aspects or elements of other embodiments to provide a plurality of additional embodiments.

1. A cellular base station, comprising:
a base station antenna that comprises:
a first set of radio frequency (“RF”) ports that has a total of N first polarization RF ports, where N is an integer that is greater than 2;
a first multi-column array of radiating elements that is configured to generate N first polarization antenna beams, the N first polarization antenna beams including a first pair of outer first polarization antenna beams and a first inner first polarization antenna beam;
a first beamforming network that electrically connects the first set of RF ports to the first multi-column array of radiating elements;
a first radio that has a first radio port that is coupled to a first of the N first polarization RF ports in the first set of RF ports, the first radio having a first maximum output power level; and
a second radio that has a first radio port that is coupled to a second of the N first polarization RF ports in the first set of RF ports, the second radio having a second maximum output power level that is greater than the first maximum output power level.

2. The cellular base station of claim 1, wherein a first RF signal that is output through the first radio port of the first radio is configured to generate one of the outer first polarization antenna beams.

3. The cellular base station of claim 2, wherein a second RF signal that is output through the first radio port of the second radio is configured to generate the first inner first polarization antenna beam.

4. The cellular base station of claim 1, wherein the second maximum output power level is at least 30% larger than the first maximum output power level.

5. The cellular base station of claim 1, wherein N is 3.

6. The cellular base station of claim 1, wherein the base station antenna further comprises a second set of RF ports that has a total of N second polarization RF ports and a second beamforming network that electrically connects the second set of RF ports to the first multi-column array of radiating elements,
wherein the first radio has a second radio port that is coupled to a first of the N second polarization RF ports in the second set of RF ports; and
wherein the second radio has a second radio port that is coupled to a second of the N second polarization RF ports in the second set of RF ports.

7. The cellular base station of claim 6, wherein the base station antenna further comprises a third set of RF ports that has a total of N first polarization RF ports, a second multi-column array of radiating elements that is configured to generate a second set of N first polarization antenna beams, the second set of N first polarization antenna beams including a second pair of outer first polarization antenna beams and a second inner first polarization antenna beam, and a third beamforming network that electrically connects the third set of RF ports to the second multi-column array of radiating elements,
wherein the first radio has a third radio port that is coupled to a first of the N first polarization RF ports in the third set of RF ports, and
wherein the second radio has a third radio port that is coupled to a second of the N first polarization RF ports in the third set of RF ports.

8. The cellular base station of claim 7, wherein the first radio and the second radio are each 4-transmit/4-receive MIMO radios.

9. The cellular base station of claim 1, wherein the first multi-column array of radiating elements comprises radiating elements that are configured to operate in at least a portion of a 1427-2690 MHz frequency band.

10. The cellular base station of claim 9, wherein the base station antenna further comprises:
a first array of radiating elements that are configured to operate in at least a portion of a 616-960 MHz frequency band;
a second array of radiating elements that are configured to operate in at least a portion of the 616-960 MHz frequency band.

11. A cellular base station, comprising:
a base station antenna that comprises a first beamforming network that is coupled to a sector-splitting antenna array, the first beamforming network and the sector-splitting antenna array configured to generate at least three first polarization antenna beams in response to respective first, second and third radio frequency (“RF”) signals,
a first radio, a second radio and a third radio that are coupled to the first beamforming network; and
a power distribution system that is configured to supply up to a first maximum amount of power to the first radio and to supply up to a second maximum amount of power to the second radio that is greater than the first maximum amount of power.

12. The cellular base station of claim 11, wherein the power distribution system is further configured to supply up to a third maximum amount of power to the third radio, where the third maximum amount of power is less than the second maximum amount of power.

13. The cellular base station of claim 11, wherein the base station antenna further comprises a second beamforming network that is also coupled to the sector-splitting antenna array, the second beamforming network and the sector-splitting antenna array configured to generate at least three second polarization antenna beams.

14. The cellular base station of claim 13, wherein the first polarization antenna beams have a -45 degree slant polarization and the second polarization antenna beams have a +45 degree slant polarization.

15. The cellular base station of claim 11, wherein the first polarization antenna beams comprise a first pair of outer first polarization antenna beams and a first inner antenna beam that is positioned in between the antenna beams of the first pair of antenna beams.

16. The cellular base station of claim 15, wherein the second radio is coupled to an input of the first beamforming network that corresponds to the first inner antenna beam.

17. The cellular base station of claim 16, wherein a high-capacity venue is within a sector served by the base station antenna and the high-capacity venue is within a main lobe of the first inner antenna beam.

18. The cellular base station of claim 11, wherein the second maximum amount of power is at least 30% larger than the first maximum amount of power.

19. The cellular base station of claim 11, wherein the first radio is coupled to a first output of the power distribution system and the second radio is coupled to a second output of the power distribution system, and the power distribution system is configured to supply up to a first maximum amount of direct current (“DC”) power to the first output of the power distribution system and up to a second maximum amount of DC power to the second output of the power distribution system, where the second maximum amount of DC power is at least 30% greater than the first maximum amount of DC power.
